(19) United States
(12) Patent Application Publication
(10) Pub. No.: US 2002/0154752 A1
(43) Pub. Date: Oct. 24, 2002

(54) Fone filter

(76) Inventor: Jon R. Carpenter, Los Angeles, CA (US)

Correspondence Address: JON R. CARPENTER, 1247 W. 30TH ST., 403, LOS ANGELES, CA, 90007, US

(21) Appl. No.: 10/103,275

(22) Filed: Mar. 21, 2002

Related U.S. Application Data
(60) Provisional application No. 60/277,557, filed on Mar. 22, 2001.

(51) Int. Cl. H04M 1/64; H04M 1/00

(52) U.S. Cl. 379/201.01; 379/88.23; 379/208.01; 379/376.02

(57) ABSTRACT

An improved telephone call filtering method that allows the user to program multiple time periods into a stand alone device or voicemail system so that the user is not disturbed by the telephone ringer during those user-defined time periods. Incoming calls during those user-defined periods are filtered with a custom greeting recorded by the user stating the privacy requested and the call is then transferred to voicemail without the telephone ever ringing. The user has the option to allow incoming callers to bypass voicemail for emergency calls by pressing a predetermined button on the caller's phone in order for the user's phone to ring.

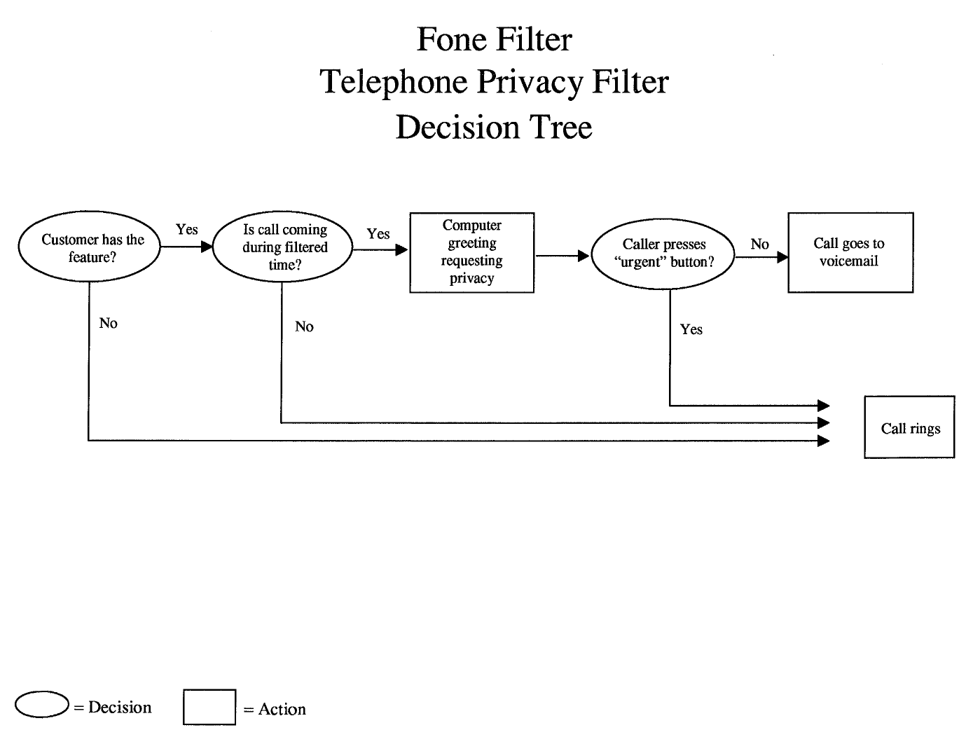

### DESCRIPTION OF PRIOR ART

U.S. Pat. No. 6,233,330 filed Oct. 13, 1998 by William McClure, et al. discloses a filtering system based on identifying individual callers through a caller identification system. However, the user must live in an area where caller identification is available, have the caller identification service and select the filtering by each and every incoming phone number. The McClure patent also requires the caller to know a code in order to get past the filtering system. The present invention differs significantly in that the present invention does not rely on caller identification technology and filters all incoming calls during predetermined time periods defined by the user. The present invention also differs significantly in that it allows for emergency calls to get through without the caller having to know a pass code. No claim was made by McClure to filter all calls based on time of day.

U.S. Pat. No. 5,388,150 filed Jul. 28, 1992 by Robin Schneyer and Jing L. Gu also discloses a filtering system but it too filters by caller identification. However, there is no claim to filter all calls based on specific times of day as the present invention does.

### SUMMARY OF THE INVENTION

The present invention provides for a method of filtering all incoming telephone calls during time periods when the user wishes not to be disturbed which prevents the telephone ringer from ringing and sends the call to a telephone answering device (TAD). The caller is greeted by a prerecorded greeting that is recorded by the user for each filtering period to inform the caller of the reason for the filter (eg. “We have gone to bed,” or “Our baby is napping,” or “We are currently having dinner” etc.) before routing the caller to a TAD. The user may also allow the caller the option of pressing a predetermined key on the caller's telephone to designate that call as an emergency call so it would ring through and bypass the TAD.

### DESCRIPTION OF THE DRAWING

The drawing is a logic diagram of the telephone filtering method rather than an exhaustive list of the methods features. For example, the diagram shows a call coming in during a “filtered time” but the invention allows for multiple filtered times, multiple greetings (one for each filtered time period) and the computer greeting would also allow the user the option of having the computer greeting tell the caller how much time is left in the filtered time period.

### DETAILED DESCRIPTION

Telephone users currently have no way of filtering incoming phone calls short of letting the phone ring and ring and then letting an answering machine or voicemail system pick up the call However, that method stir allows the phone to ring which can wake people in the middle of the night, bother them during dinner or family time, or wake napping children. The telephone ring alone disturbs the peace of the home by suggesting there is something urgent and more important to attend to.

With the “Fone Filter” Telephone Privacy Filter built into answering machines and voicemail systems, people could select periods of the day when they wish not to be disturbed, such as dinner time, the time their children nap, or private time when they simply want some quiet privacy. It works like this:

On an answering machine or voicemail system, the user would select a time period he/she would prefer that the phone doesn't ring at all For example, Mrs. Smith's baby naps from noon to 1 p.m. every day. Mrs. Smith could program her system to greet all callers during that time period with a custom message that she would record herself, something to the effect of, “Thank you for calling the Smiths. Our baby naps during this time so we prefer not to take phone calls until after one o'clock. If your call is an emergency and you need to speak with us immediately, press 9 for your call to ring through, otherwise, leave a message after the beep.” The option for the caller to press 9 (or whatever button is determined to be optimal) for the call to go through for emergency matters allows for flexibility in that the phone customer is not cut off from the world. The Smiths also go to bed early at 9 p.m. so they don't want to receive any phone calls after 9 p.m. or before 6 a.m. so Mr. Smith programs the system to greet callers during that time period with, “Thank you for calling the Smiths. We have gone to bed for the night. If your call is an emergency press 9, otherwise please leave a message.” Both time periods are saved on the system and run automatically during the specified time periods and the caller is warned that unless it's an emergency, their call is not welcome, but the caller is free to leave a message.

The Jones family, on the other hand, has a much more hectic and chaotic schedule. They are willing to take phone calls as long as they aren't having dinner or haven't gone to bed, but sometimes they eat at 6 p.m. and go to bed at 10 p.m. and sometimes they eat at 9:30 p.m. and go to bed at 1 a.m. The user prerecords the filtered greeting such as the “We're having dinner” or “We have gone to bed” messages and then activates the filter whenever they want for the duration of their choosing. For answering machines it can be a series of hotkey buttons or for voicemail systems it can be activated by a code on the keypad, such as *55 followed by the number of minutes they want privacy (similar to *69 for returning phone calls).

The filter can also be set to specific days of the week. For example, the Jones family sets their filter to activate at various times at night when they go to bed but they always want it to terminate by 6 a.m. on weekdays. However, Sunday morning is their sleep-in-and-read-the-paper-in-pajamas morning and they want the filter to stay on until 10 a.m.

The system would also have a feature to allow the user to elect to have the filter automatically switched off if anyone picks up the phone, so if Mr. Jones sets the filter for dinner to last 60 minutes, but they finished early after only 30 minutes, they won't have to hassle with codes or buttons to disengage the filter.

There is no other system or process being utilized to give telephone customers this kind of flexibility and control over the intrusion of the telephone ring which is why this invention is so novel and important.

References Cited

U.S. Patent Documents

U.S. Pat. No. 6,233,330 May, 2001 McClure, et al. 379/212

U.S. Pat. No. 5,388,150 February, 1995 Schneyer, et al. 379/88

### BACKGROUND

Telephone users are often disturbed by the telephone ringing. Even when users don't want to be disturbed and expect an answering machine or voicemail service to take a message when a call comes in, the phone still rings several times before the message is taken. That ringing can disturb people while sleeping, wake napping children, interrupt dinner, distract the user from work, etc. The only alternative is to turn the phone ringer off completely, but then emergency calls can't get through and the user has to remember to turn the ringer back on.

### DESCRIPTION OF PRIOR ART

1) U.S. Pat. No. 6,233,330 filed Oct. 13, 1998 by William McClure, et al. discloses a filtering system based on identifying individual callers through a caller identification system. However, the user must live in an area where caller identification is available, have the caller identification service and select the filtering by each and every incoming phone number. The McClure Pat. also requires the caller to know a code in order to get past the filtering system. The present invention differs significantly in that the present invention does not rely on caller identification technology and filters all incoming calls during predetermined time periods defined by the user. The present invention also differs significantly in that it allows for emergency calls to get through without the caller having to know a pass code. No claim was made by McClure to filter all calls based on time of day.

2) U.S. Pat. No. 5,388,150 filed Jul. 28, 1992 by Robin Schneyer and Jing L. Gu also discloses a filtering system but it too filters by caller identification. However, there is no claim to filter all calls based on specific times of day as the present invention does.

I claim:

1. A telephone filtering method that:
a) allows the user to define the filtered time periods the user does not want to be disturbed;
b) allows the user to record a personalized greeting for each filtered time period;
c) allows the predetermined filtered time periods to activate automatically,
d) allows the user to activate filtered time periods manually,
e) checks incoming calls to see if they occur during a filtered time period;
f) restricts the telephone ringer from ringing if the call comes during a filtered time period;
g) plays the prerecorded greeting for the caller if call comes during filtered period;
h) routes the call to a telephone answering device if the call comes during a filtered period after playing the rerecorded greeting;
i) allows the user the option to permit callers to press a predetermined button on their phone to designate their call as an emergency to avoid the telephone answering device and for the user's phone to ring;
j) provides a countdown timer for the filtered time period so the user has the option of the device informing the caller of how much time is left in the filtered time period.
